(19) United States
(12) Patent Application Publication
(10) Pub. No.: US 2022/0273055 A1
(43) Pub. Date: Sep. 1, 2022

(54) Improved Filtering Face Masks and Breathing Apparatuses

(71) Applicant: Boston Mask Company, LLC, Brookline, MA (US)

(72) Inventor: Christian Picker, Brookline, MA (US)

(73) Assignee: Boston Mask Company, LLC, Brookline, MA (US)

(21) Appl. No.: 17/447,988

(22) Filed: Sep. 17, 2021

Related U.S. Application Data
(60) Provisional application No. 63/154,932, filed on Mar. 1, 2021.

(51) Int. Cl. A41D 13/11

(52) U.S. Cl. CPC A41D 13/1161; A41D 13/1115; A41D 2400/38

(57) ABSTRACT

Improved breathing apparatuses and related systems and methods for preventing airborne viruses and contaminants within an aerosol from being either inhaled by a user or equally exhaled by said user. In one embodiment, the improvement comprises a first outer filtering layer comprised of a pneumatically porous material and ear loops and a second inner filtering layer comprised of a pneumatically porous material, a cap perforating said inner filtering layer and ear loops. In a second embodiment, the invention comprises a solution to improve the seal of a face mask against the wearer's face by providing a flexible clip-on attachment lying between the face and the top edge of the mask.

### CROSS-REFERENCE TO RELATED APPLICATIONS

This application claims priority to Provisional Application No. 63/154,932 filed on Mar. 1, 2021, the contents of which is incorporated herein by reference.

### FIELD OF THE INVENTION

The present invention relates to breathing apparatuses, systems and methods, and more particularly, to breathing apparatuses which are adapted to prevent airborne viruses and contaminants within an aerosol from being either inhaled by a user or equally exhaled by said user.

### DESCRIPTION OF THE RELATED ART

The recent COVID epidemic has demonstrated the value of the population wearing masks that control the exhaling and inhaling of aerosols from the human body. Such exhalations occur when a human breathes, coughs or sneezes. Unfortunately, such masks suffer from many shortcomings, including fogging a user's eyeglasses, making them re-breathe their exhaled air, accumulating moisture near the facial surface covered by the mask and general discomfort.

The above leads many users to wear the mask incorrectly (such as with the nose outside it). What is needed, is an easy to don, easy to use and easy to keep available mask assembly that provides a comfortable yet aerosol proof intake breathing path and an easy to exhale path for used air that does not direct air towards a user's eyes.

A product as universal as a face mask needs to work in a universally effective way for its users. Many users consistently report discomfort after wearing their masks for extended periods of time, often citing dampness, facial irritation, resistance to easy airflow, and other factors. One of the user groups most adversely affected by current face masks are wearers of glasses. These users are prone to the warm, damp air of their breath being forced up and out the top of the mask and condensing onto the lenses. For those who rely on both eyewear and face masks for daily use, these adverse effects extend beyond just comfort and can put the wearer in danger by decreasing their visibility.

Many existing face masks try to mitigate this problem by embedding thin metal strips along the top edge of the mask, allowing the user to bend the mask to the shape of their face to make a better seal. Although this feature may help mitigate the problem for some, it fails for many others and has some inherent flaws. First, a metal strip alone tends to deform over time and loses the shape it was given by the user. Second, a metal strip alone often does not conform closely enough to the full profile of the wearer's face to cut off upward airflow upon exhale. These two issues result in a weak and incomplete seal along the top edge of the mask, which allows the wearer's breath to easily rise up onto the lenses of their eyewear. This lack of a seal may also provide additional concern about the ability of viruses to spread beyond the edges of a mask, rather than getting trapped in the mask as intended. In another aspect, this patent proposes a solution to improve the seal against the wearer's face by providing a flexible clip-on attachment lying between the face and the top edge of the mask.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

In one aspect, the invention is about a breathing apparatus, comprising a first outer filtering layer comprised of a pneumatically porous material and ear loops and a second inner filtering layer comprised of a pneumatically porous material, a cap perforating said inner filtering layer and ear loops.

In one embodiment, the inner filtering layer may be manufactured from cloth, paper, nylon or a combination of these and other suitable semi-permanent material, so that a user may use it for an extended period of time (as long as a week), while the outer layer may be made from any of these materials, it is preferably made from a low-cost material (like paper) so it may be disposed of daily or even sooner if conditions require it.

In another aspect, the invention comprises a solution to improve the seal of a face mask against the wearer's face by providing a flexible clip-on attachment lying between the face and the top edge of the mask.

### BRIEF DESCRIPTION OF THE DRAWINGS

FIG. 1. shows the front or outside of a first embodiment of the mask.

FIG. 2. shows the back or inside of the first embodiment of the mask.

FIG. 3. shows the side of the first embodiment of the mask with a gap around the edges of certain filtering layers.

FIG. 4 shows the center cap of the first embodiment.

FIG. 5 shows a second embodiment of the invention with a clip-on attachment along the top edge of the mask.

FIG. 6 shows an exemplary construction of the clip-on attachment.

FIG. 7 shows the assembled construction of the clip-on attachment in an exemplary embodiment.

FIG. 8 shows the orientation of the clip-on attachment with respect to the mask.

FIG. 9 shows the placement of the clip-on attachment on a surgical mask.

FIG. 10 shows the detailed assembly of the clip-on attachment in an exemplary embodiment.

FIG. 11 shows the back or inside of a mask with the clip-on attachment attached.

FIG. 12 shows an exemplary shape and exemplary dimensions for fabrication of a first piece of the clip-on attachment according to one method of manufacture.

FIG. 13 shows an exemplary first piece of the clip-on attachment fabricated by injection mold.

FIG. 14 shows an exemplary shape and exemplary dimensions for fabrication of a second piece of the clip-on attachment according to one method of manufacture.

FIG. 15 shows how a first and second piece are assembled to create the clip-on attachment according to one method of manufacture.

FIG. 16 shows exemplary shape and dimensions for a metal band skeleton for inclusion in the pad addition.

FIG. 17 shows an exemplary metal band skeleton fabricated with die cut aluminum.

FIG. 18 shows another exemplary skeleton in an alternative shape.

FIG. 19 shows an alternative, preferred method of manufacture in which silicone is molded over the skeleton.

### DETAILED DESCRIPTION OF THE INVENTION

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

This patent proposes a solution to improve the seal against the wearer's face by providing a flexible clip-on attachment lying between the face and the top edge of the mask. To achieve an effective seal, this attachment must be made of a material that can create a sufficient suction-like barrier that would redirect airflow entirely and/or effectively absorb moisture. Two advantageous assemblies for this purpose include (1) a molded silicone piece with a concave surface that easily and effectively forms a seal against the wearer's face and (2) a low-density closed-cell foam piece that follows the contours of the wearer's face and absorbs or redirects any moisture from the wearer's breath. Either solution could function as an accessory that users could attach and conform to their existing face masks using a support structure, referred to herein as a skeleton, which may be a flexible strip made of aluminum or any other material that will mold or contour to any shape face. The skeleton may extend across the entire width of the attachment, and thus across the entire width of the face mask, allowing the user to fully conform the attachment to the shape of their face. The skeleton may attach to existing masks using two protruding clips of the same material that can be bent and clamped down onto the mask. Alternatively, this invention could be fabricated as an integrated part of a mask rather than as a removable attachment. While embodiments of the invention are referred to herein as a clip-on attachment, it should be understood that the same principles would apply when the invention is manufactured as part of a mask rather than an attachment.

In one embodiment, a clip-on attachment made from foam could take the form of a long, thin extruded profile with two humps positioned at approximately the ⅓ and ⅔ marks along the length. These humps are intended to fill the concave area between the wearer's cheeks and nose, which are typically the least-sealed areas on current masks. The skeleton (i.e., metal strip or other supporting structure) used to attach the foam to the mask would be adhered on the back surface of the foam piece. Foam has the benefit of being cheap and easy to manufacture. In such a configuration, manufacturing could be possible by die-cutting, injection-molding, or extrusion and slicing of the material. In addition, foam provides a soft and comfortable cushion against the user's face, effectively absorbs moisture, and can be reused on multiple occasions or on several different masks. The low manufacturing cost of the foam variation could make it advantageous for single or disposable use. Other materials with similar properties, such as hypoallergenic wool, may be used with this embodiment of the invention.

In an alternative embodiment, a clip-on attachment made from silicone would take on a similar overall profile to the foam embodiment but would feature additional surface contours that permit an effective seal to form against the wearer's face. Specifically, a long and slender profile with humps near the cheeks would be formed, but the surface resting against the wearer's face would be concave in order to provide a suction-based seal onto the face. This concave surface thereby creates thin flaps of silicone that can easily bend around and form a seal against the wearer's cheeks. Such a design could be manufactured via injection molding, preferably with the skeleton inserted into the mold and entirely coated in silicone. While this embodiment may be advantageously constructed from molded medical grade silicon, it could also be manufactured from other types of soft injection moldable material shaped with moldable flaps. Although such a design may not be as cheaply or easily manufactured as its foam counterpart, advantages of a silicone version include increased longevity and ease of sanitization.

This product could be easily scaled to fit different face sizes, and therefore might be sold in a number of different form factors, such as small, medium, and large. Additionally, the proposed designs can be adapted to better suit different shapes and types of masks; some versions might follow a straight edge along the top of a mask, while others might curve upwards at the nose. The specific shapes and contours of the proposed design may be iteratively adapted or modified to better suit various face shapes while still preserving the original spirit of the innovation described in this patent.

In some embodiments, the shaped silicon, foam or other material may be attached to the skeleton or support structure permanently. In other embodiments, the shaped silicon, foam or other material may be removed and placed upon different skeletons with different dimensions to aid in creating a seal along the contour of the nose and cheeks.

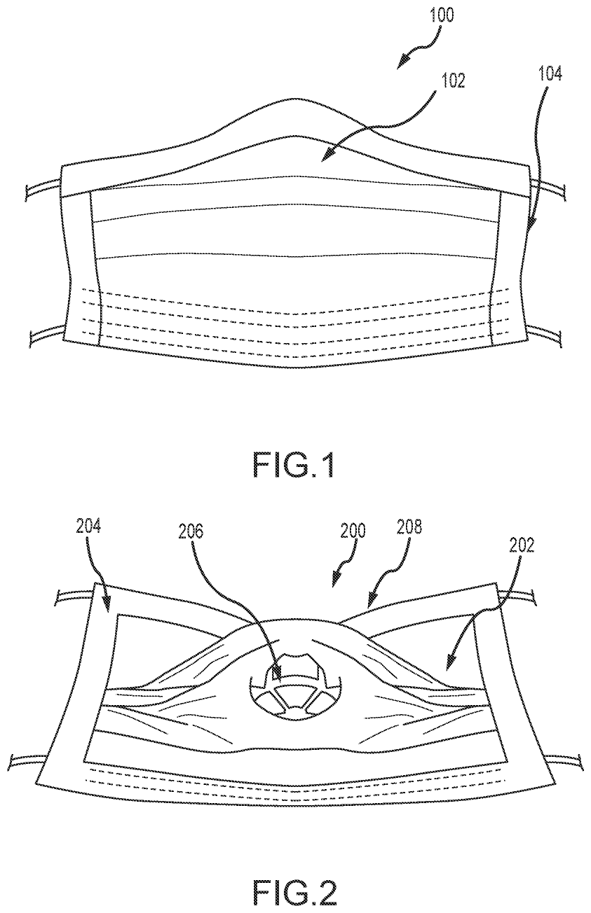

Referring to FIG. 1 we see a first proposed embodiment 100 of the EZ Comfort mask. The front of the mask 100 is comprised of a disposable outside filtering layer 102, which is held against the user via mechanical or chemical components that include ear loops 104 or bonding to the face but allow for the user to inhale and exhale.

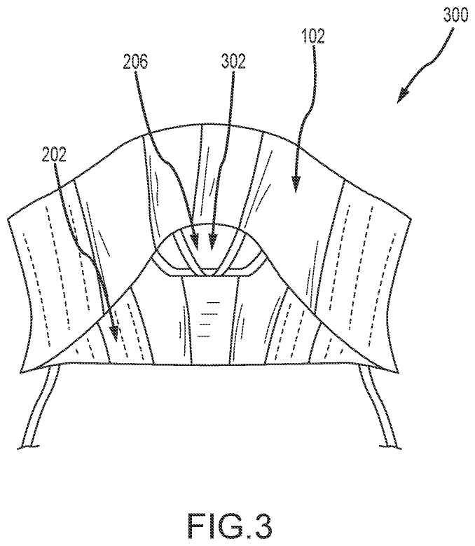

FIG. 2 shows the inside of the mask in its first proposed embodiment. The mask also comprises an inner filtering layer 202, and in some instances, additional ear loops 204, which may be parallel to ear loops of the front layer 102. In another embodiment, the ear loops 104, 204 are replaced by a headband connection, so that the user simply slides the mask 100 up/down from said headband. A center cap 206 is disposed at or near the center of the inner filtering layer 202. Center cap 206 may be configured in a number of different ways. In one configuration, center cap 206 has a one-way valve, which allows the exhaled air to easily leave the area around the face and to go out, but which seals when the user inhales.

In this configuration, there may be a gap 302 left around the edges of filtering layers 102/202, as shown in FIG. 3. In another configuration, center cap 206 has filtering material of its own, sufficient to slow down the airflow. In another configuration, center cap 206 is clear. In both of these latter configurations, gap 302 is reduced in size or eliminated altogether to prevent any unfiltered air from being inhaled.

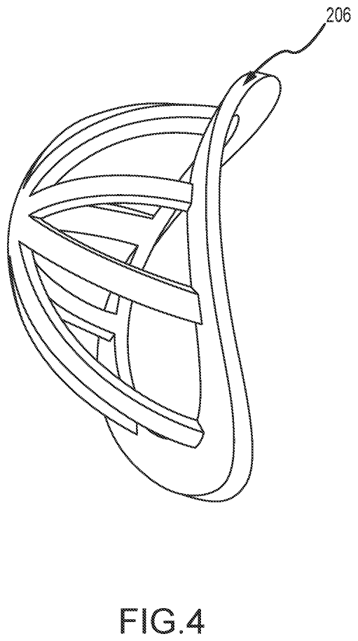

FIG. 4 shows one embodiment of center cap 206. In this embodiment, structural members extend outwards from a base, which is in the shape of an oval. The oval base faces the inside of the mask and may be in contact with the wearer's mouth or face. The structural members create space for exhalation.

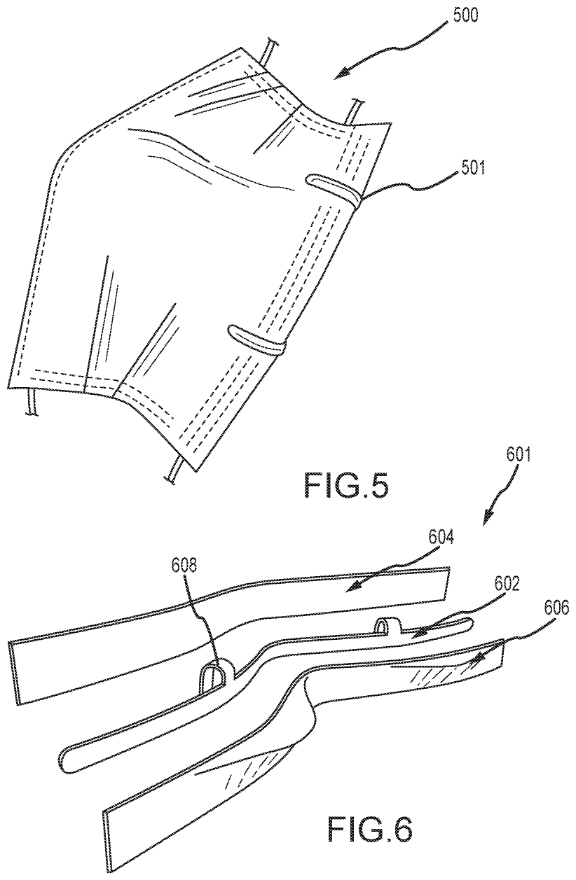

In FIGS. 5-21, we see a solution to a problem most masks have. Most masks may cause a user's eyeglasses or sunglasses to “fog up” as the user exhales warm, humid air, which is directed upward across the surface of the user's glasses.

In one embodiment, shown in FIG. 5, the mask 500 has an addition of a clip-on attachment 501 in the area below the top of the mask along the inner side of the mask disposed parallel to the top of the mask. In one embodiment this is done only in the inside of the inner layer 202. In another embodiment, both the inside of the inner layer 202 and the outside of said layer. This pad outside the layer will be sandwiched with the outer filter 102, resulting in minimal hot moist exhaled air contacting the user's glasses.

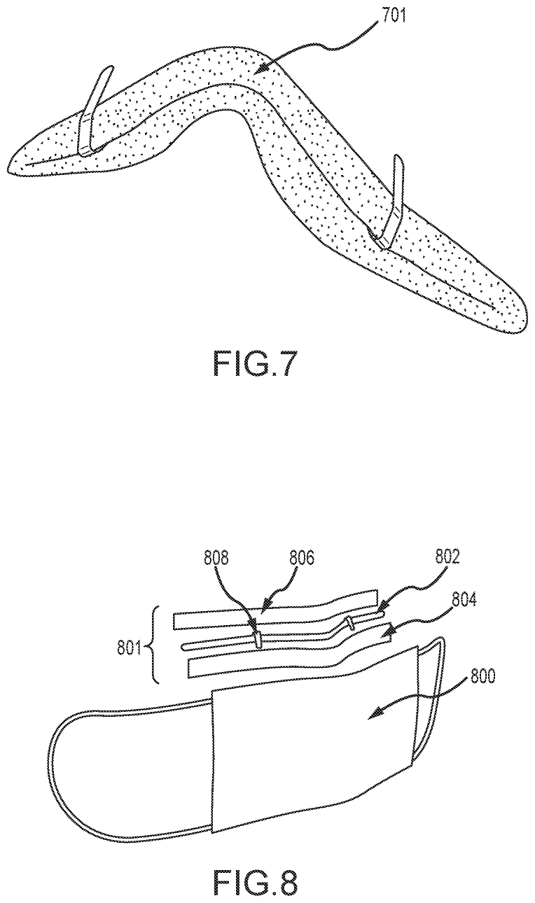

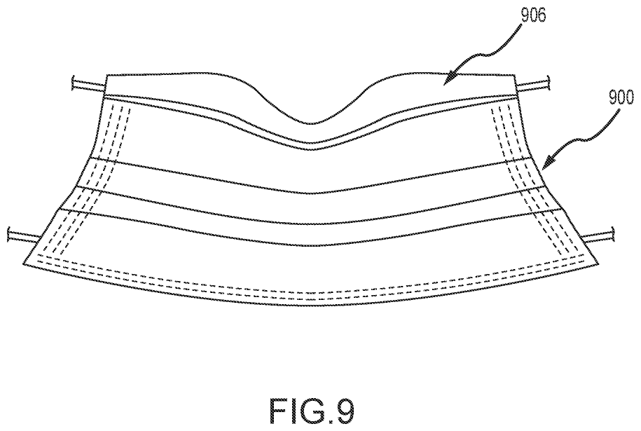

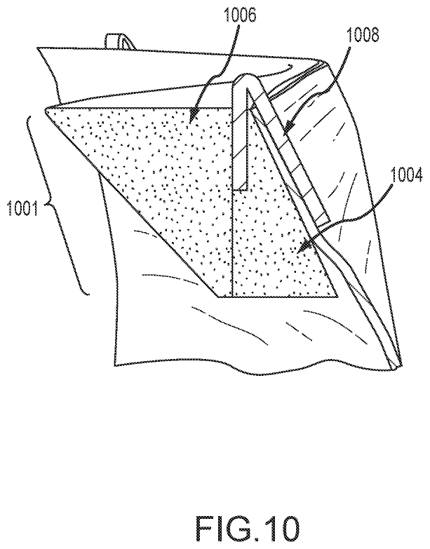

In another embodiment, partially illustrated in FIG. 6, the clip-on attachment is a standalone piece that may be fitted to any mask (for example, the mask depicted in FIG. 5). An assembly 601 is comprised of a flexible central tab or skeleton 602 and two pieces, a first piece 604 and a second piece 606, which may be constructed from foam, silicone or other materials with similar properties. One or more mechanical attachment components 608 are fitted so that the assembly 601 may be attached to the mask. FIG. 7 is another view of the assembly 701. FIG. 8 illustrates the orientation of assembly 801 and its constituent parts (skeleton 802, first piece 804, second piece 806) and how clips 808 may be used to attach the assembly to the mask 800. FIG. 9 illustrates the placement of the assembly, with second piece 906 closest to the user's face, along the top edge of the mask 900. FIG. 10 shows a crosssection view of one embodiment of the clip-on attachment attached to a mask. Assembly 1001, comprising first and second pieces 1004 and 1006, respectively, is attached to the top of the mask with clips 1008.

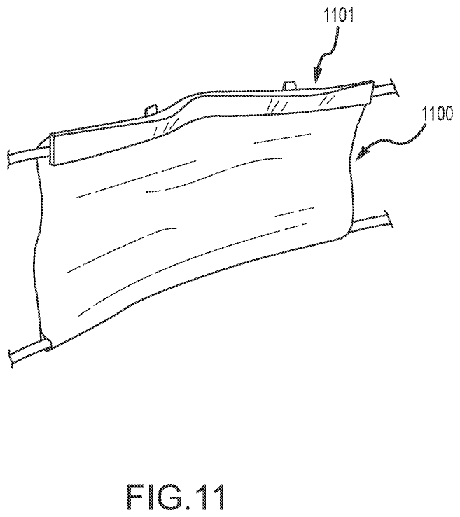

FIG. 11 shows a view of the assembly 1101 attached to a cloth mask 1100. Assembly 1101 may be used on a variety of masks and moved from one mask to another.

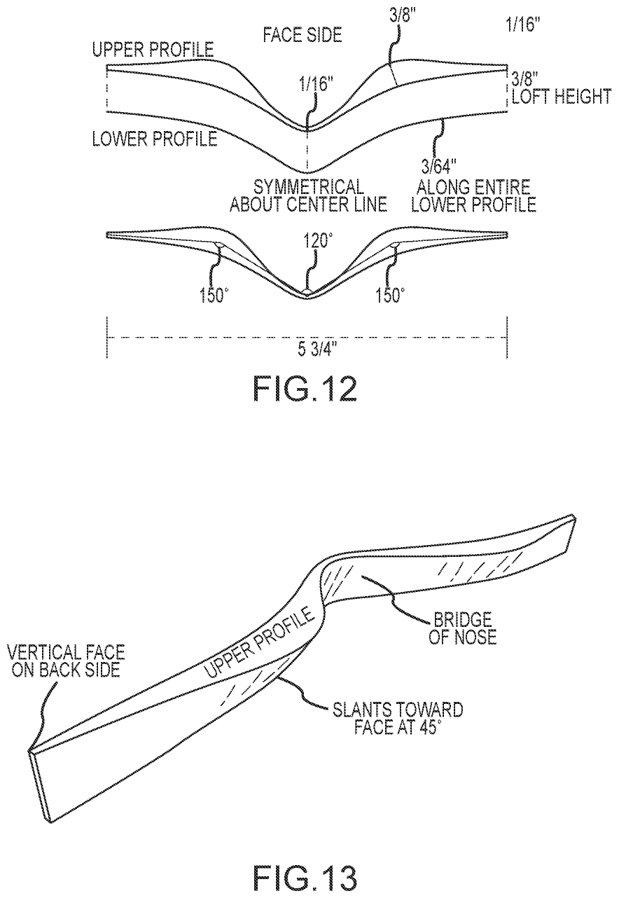

FIGS. 12 and 13 illustrate exemplary dimensions of a first piece of the clip-on attachment. As can be seen from FIG. 12, the first piece is symmetrical laterally about the center line. The first piece may have a concave shape about the center line forming an angle of substantially 120 degrees. Looking outward from center in both directions, the first piece may be formed with a convex shape with an angle of substantially 150 degrees.

As shown in FIG. 13, the concave shape around the center line accommodates the bridge of the user's nose. The convex shape slants toward the face at a about 45 degree angle from vertical. At the ends, the first piece has a substantially vertical face. The 45 degree angle slant is selected to fit a representative human face, but the angle of the slant may be greater or smaller to accommodate other face shapes. The exemplary shape of this first piece in FIGS. 12 and 13 could be manufactured in several ways including by injection molding with either silicone or open-cell foam.

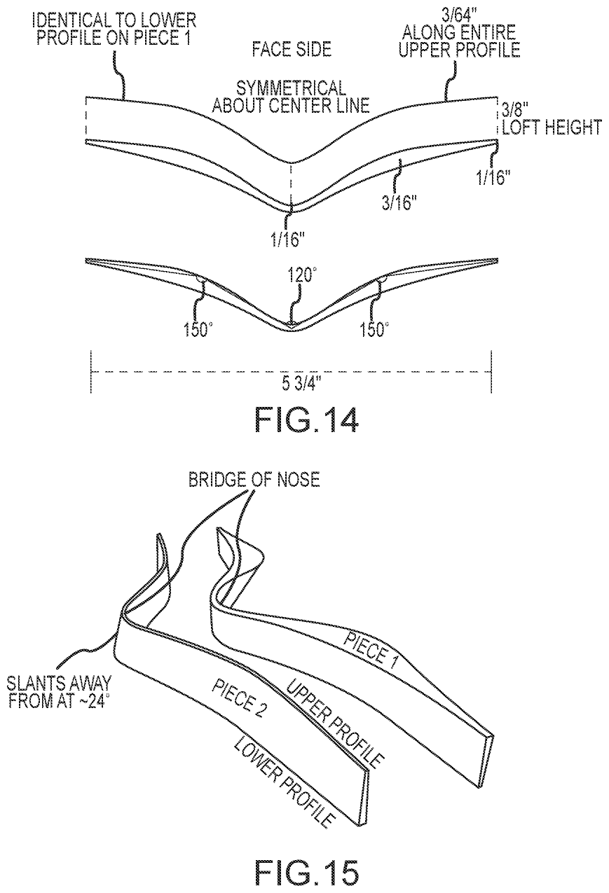

FIGS. 14 and 15 illustrate the exemplary dimensions of a second piece of the clip-on attachment and how the first and second piece fit together, respectively. The second piece is also symmetrical about the center line and fits along the outer face of the first foam piece. The thickness of the second piece varies along its length. At center line, the second piece may have a narrower thickness in the range of 1/16 inches. At the center of the convexity, the second foam piece is thicker, in the range of 3/16 inches. The overall length of the second piece may be about 5¾ inches.

As shown in FIG. 15, the outer face of the first piece and inner face of the second piece are substantially the same shape and fit together. The outside of the second piece may slant away from the face at an angle of about 24 degrees. The 24 degree angle slant is selected to fit a representative human face, but the angle of the slant may be greater or smaller to accommodate other face shapes.

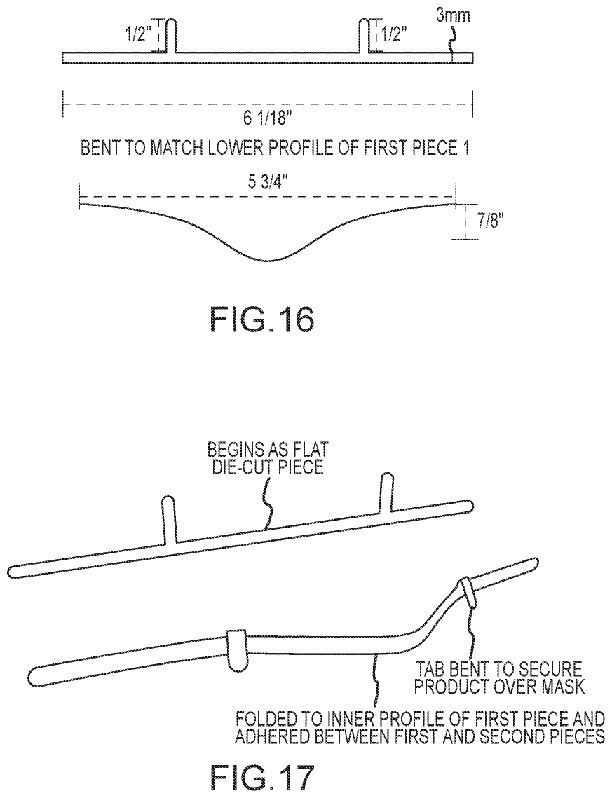

FIGS. 16 and 17 illustrate the exemplary skeleton components according to one embodiment. The skeleton attachment components may be pressure clips, attachment clips or any other suitable easy to attach mechanism. FIG. 16 illustrates exemplary dimensions of the attachment components. The overall length may be about 6⅛ inches. The clip portions may be about ½ inches prior to deformation during assembly. The tab and attachment components may be formed from a metal band for rigidity and flexibility and bent to match the lower profile of the first piece. When bent, the overall length of the tab and attachment components matches the length of the first piece, which in this exemplary assembly is 5¾ inches.

FIG. 17 illustrates one possible manufacturing and shaping method for producing the skeleton attachment components. A metal band may be formed out of aluminum via a die-cut process. The thickness of the aluminum may be in the range of 0.75 mm. The metal piece is initially flat but may then be bent to match the shape of the first piece. The metal piece is secured between the first and second pieces, for example with use of adhesive. Additionally, the tabs are bent to secure the assembly to the mask.

Other manufacturing and shaping methods may be used. For example, the band may be made from any material that is able to be molded to the human face. Suitable materials include memory wire or plastic, the main criterion being that the materials molds to a generic or average face contour but may adopt the contour of a different shape face when worn by an individual whose face has a different shape.

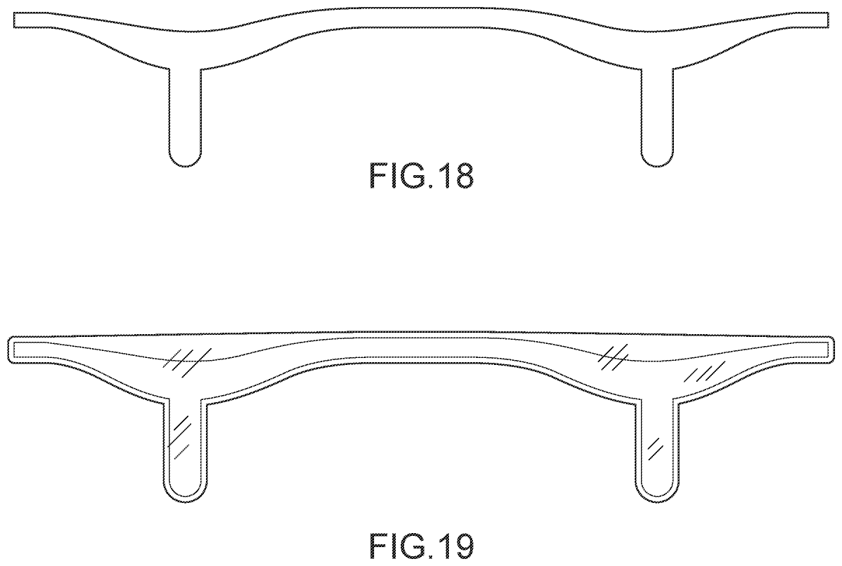

FIG. 18 shows an alternative shape for the skeleton, in which the structural component curves upward at each of the tabs. The resulting shape may be more easily formed to seal against an average face and also more comfortable to wear.

FIG. 19 shows an alternative method of manufacture for the clip-on attachment. The skeleton may be placed inside an injection mold and over molded with silicone or another suitable material. This method may be faster and simpler than the assembly method illustrated in FIGS. 10, 12-15.

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means- or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

What is claimed is:

1. A clip-on attachment for a face mask comprising:
a structural component with deformable clips and
a volume surrounding the structural component,
wherein the deformable clips are operable to attach to a top edge of the face mask such that the volume is disposed along the top edge of the face mask; and
wherein the volume is operable to prevent exhaled breath from escaping along the top edge of the face mask.

2. The clip-on attachment of claim 1, wherein the volume comprises silicone.

3. The clip-on attachment of claim 2, wherein the structural component comprises an aluminum strip.

4. The clip-on attachment of claim 1, wherein the volume comprises open-cell foam.

5. The clip-on attachment of claim 1, wherein the volume further comprises:
a first piece disposed proximate to the face mask; and
a second piece disposed proximate to a face of a user.

6. The clip-on attachment of claim 1, wherein the volume comprises a single, over-molded piece.

7. A face mask comprising:
a filtering sheet;
two ear loops;
a structural component; and
a volume surrounding the structural component,
wherein the volume is disposed along a top edge of the filtering sheet; and
wherein the volume is operable to prevent exhaled breath from escaping along the top edge of the filtering sheet.

8. The face mask of claim 7, wherein the volume comprises silicone.

9. The face mask of claim 7, wherein the structural component comprises an aluminum strip.

10. The face mask of claim 7, wherein the volume comprises open-cell foam.

11. The face mask of claim 7, wherein the volume further comprises:
a first piece disposed proximate to the face mask; and
a second piece disposed proximate to a face of a user.

12. The face mask of claim 7, wherein the volume comprises a single, over-molded piece.
